(19) United States
(12) Patent Application Publication
(10) Pub. No.: US 2026/0237367 A1
(43) Pub. Date: Aug. 13, 2026

(54) SYSTEM AND DEVICE FOR ELECTRIC BOW MECHANISM FOR STRING INSTRUMENTS

(71) Applicant: PICKASO INNOVATIONS LTD., Bnei Brak (IL)

(72) Inventors: Yonatan SHENHAV, Bnei Brak (IL); Oron LAZAROVICH, Bnei Brak (IL); Alexey RUBINCHIK, Bnei Brak (IL)

(21) Appl. No.: 19/459,115

(22) Filed: Jan. 26, 2026

(30) Foreign Application Priority Data
Feb. 9, 2025 (IL) 318905

(51) Int. Cl. G10D 3/16

(52) U.S. Cl. CPC G10D 3/16

(57) ABSTRACT

The present patent application relates to a bow mechanism for string instruments, designed for continuous and controlled sound production. The mechanism comprises a rotating wheel encircled by a circumferential layer, where a first portion is tightly secured around the wheel and a second portion extends outward, forming a gap. When the wheel rotates and the second portion is pressed against at least one string, vibrations are induced, producing sound. In some embodiments, the wheel is elastic, enhancing flexibility during bowing. In further embodiments, the circumferential layer is wrapped with natural or synthetic hair strands, secured by interweaving, anchoring, or a tension-locking mechanism, mimicking traditional bow hair for improved friction and tonal control. The mechanism is adaptable for various string instruments, including violins, cellos, and guitars, for both acoustic and electric applications.

### CROSS REFERENCE TO RELATED APPLICATIONS

This application claims the benefit of the benefit of priority of Israeli Patent Application No. 318905, filed February 9, 2025, the contents of which are all incorporated herein by reference in their entirety.

### TECHNICAL FIELD

The present invention generally relates to the field of musical instruments, and particularly to bowing mechanisms for string instruments. More specifically, the invention pertains to a rotational bow mechanism that utilizes a rotating wheel with a circumferential layer to induce vibrations in a string, thereby generating sound. This mechanism is applicable to various string instruments, including violins, cellos, and guitars, in both acoustic and electric settings.

### BACKGROUND

Bowed string instruments, such as the violin, viola, cello, and double bass, produce sound through the vibration of their strings, typically induced by a bow. The bow, traditionally made of a flexible wooden stick with horsehair coated in rosin, creates friction with the strings, causing them to vibrate and generate sound. The bow’s design allows musicians to control dynamics, articulation, and tone, enabling various playing techniques such as legato (smooth transitions), staccato (short detached notes), and spiccato (bouncing strokes).

The interaction between the bow and strings is based on the stick-slip effect, where the rosin-coated horsehair temporarily adheres to the string before releasing it, causing rapid cycles of gripping and slipping. This cyclical motion generates periodic vibrations, whose frequency and timbre are determined by factors such as the string’s length, tension, and material composition.

Despite its effectiveness, the traditional bowing technique has inherent limitations. A key limitation is that manual bowing requires repeated changes in direction, which interrupts sustain and hinders the production of infinitely sustained tones. Additionally, the design of conventional bows does not easily accommodate non-bowed string instruments, such as guitars and harps, limiting their ability to replicate the expressive and tonal qualities of bowed instruments.

Various mechanized solutions have been introduced to address these challenges, yet they suffer from significant drawbacks. For example, the Gizmotron (www.gizmotron.com), which uses motorized silicone wheels to vibrate guitar strings, is limited by its fixed mounting, lack of dynamic control, and restricted compatibility with instruments beyond guitars.

Similarly, the Infinity Bow Prototype that was published on instagram (www.instagram.com/reel/C6mtRkGPGpU/), incorporates motorized plastic wheels, produces excessive mechanical noise due to its rigid material, which prevents smooth articulation and dynamic expression.

Another device, the E-Bow (www.ebow.com), employs electromagnetic fields to induce vibrations in electric guitar strings, but its functionality is limited to electric instruments and its sound lacks the natural tonal characteristics of a traditional bow.

To summarize, existing solutions for producing sustained bowed sound suffer from multiple issues. They either fail to provide infinitely sustained tones, lack versatility across different string instruments, or introduce mechanical noise and operational limitations that hinder their practical usability.

Moreover, current systems do not allow for rapid string transitions or simultaneous engagement of multiple strings, further restricting their effectiveness in live performances and recording environments.

Therefore, there is a pressing need for an advanced electric bow mechanism that provides continuous, expressive bowed sound across multiple instruments. Such a mechanism must overcome the limitations of existing solutions while offering seamless playability, precise tonal control, and enhanced musical versatility.

### GENERAL DESCRIPTION

### Introduction

The present invention relates to devices and systems for sound production on string instruments using a bow mechanism. This innovative approach enables continuous, natural, and controlled sound generation on string instruments, including guitars, violins, cellos, and other stringed or bowed instruments.

The disclosed mechanism comprises a rotating wheel encircled by a circumferential layer, which includes a first portion secured tightly around the outer circumference of the wheel and a second portion extending outwardly, thereby forming a gap around the outer circumference of the wheel. When the wheel rotates and the second portion is pressed against at least one string, it induces vibration, producing sound.

Unlike traditional bowed instruments that rely on manual bowing techniques, this motorized system allows for consistent and uninterrupted bowing, enhancing tonal expression and sustain. The invention is adaptable to various string instruments and materials, making it suitable for both acoustic and electric applications while addressing limitations of prior art devices.

### Terms and General Comments

The term "wheel" may refer to any circular structure configured to rotate around a rotation axis, designed for interaction with the string of a string instrument.

The term "circumferential layer" may refer to a layer encircling the wheel, which includes at least a first portion secured tightly around the outer circumference of the wheel and a second portion extending outwardly from the first portion, forming a gap around the outer circumference of the wheel. The second portion, characterized by elasticity, is configured to be pressed against at least one string of a string instrument to generate sound.

The circumferential layer may also be formed as an integral part of the wheel, rather than a separate layer wrapped around it. In this configuration, the outer surface of the wheel itself functions as the circumferential layer, eliminating the distinction between a first portion and a second portion. The material composition and surface texture of the integrated circumferential layer can be designed to optimize friction and interaction with the string, including the incorporation of grooves, protrusions, or embedded natural or synthetic hair strands. This integrated design enhances durability, simplifies construction, and ensures a seamless connection between the wheel and the circumferential layer, maintaining the mechanism’s ability to produce continuous bowed sound.

The term “elasticity” or “elasticity element” may refer to a structural and material composition that allows the mechanism or the wheel or the circumferential layer to exhibit controlled deformation and elastic recovery when subjected to force, similar to the elasticity of a violin bow under tension. This means that the mechanism or the wheel or circumferential layer is neither entirely rigid nor excessively soft; rather, it possesses an optimal balance between stiffness and resilience, enabling it to adapt dynamically to variations in string pressure while maintaining a stable rotational motion.

The elasticity of the wheel or circumferential layer ensures that it can absorb and respond to minor fluctuations in pressure, allowing for smooth, continuous contact with the string without excessive dampening or rigidity that could hinder tonal production. In some configurations, elasticity also includes the ability of the wheel or circumferential layer to elastically retreat when pressed against a string, enabling controlled deformation upon contact and restoring its shape upon release. This capability enhances friction modulation and energy transfer, optimizing the ability to induce string vibrations efficiently.

Materials used to achieve this level of controlled elasticity may include composite polymers, laminated wood structures, elastomeric compounds, or engineered fiber-reinforced materials, each designed to provide a Young’s modulus (elastic modulus) in the range of approximately 5 GPa to 20 GPa (for common materials used in violin bows). This range ensures a balance between structural stability and necessary deformation under load, closely resembling the elasticity found in violin bows and traditional bowing mechanics. The goal is to replicate the responsiveness and natural bowing behavior found in traditional violin bows while integrating modern, durable materials to enhance longevity and consistency in performance.

The elasticity of the mechanism may result from external shock absorbers, the structural design, or the material composition of the wheel or circumferential layer, allowing controlled deformation, optimized friction, and improved responsiveness.

By incorporating elastic retreat as part of the elasticity principle, the mechanism allows either the wheel or the circumferential layer to momentarily deform upon contact with the string, ensuring optimal friction and interaction while preventing excessive resistance. This feature provides additional adaptability, ensuring a smooth and controlled bowing experience across different playing dynamics.

The term "motor" may refer to any device capable of converting electrical or other forms of energy into rotational energy, used to drive the rotational movement of the wheel.

The term "string" or "string of a string instrument" may refer to any tensioned wire or filament on a musical instrument, including but not limited to guitars, violins, cellos, banjos, and harps, capable of producing sound through vibration.

For the sake of clarity, the mechanism(s) described in the embodiments of the present disclosure may be referred to hereinafter as "bow mechanism," "mechanism for bowed sound production," or "bow system" interchangeably.

Accordingly, the wheel and circumferential layer components described in the embodiments may be referred to hereinafter as "rotational bow assembly" or "wheel and layer assembly" interchangeably.

References to "one embodiment," "an embodiment," "preferred embodiment," or "various embodiments" indicate that the embodiment(s) so described may include a particular feature, structure, or characteristic, but not every embodiment necessarily includes the particular feature, structure, or characteristic. Additionally, repeated use of the phrase "in one embodiment" does not necessarily refer to the same embodiment, although it may.

The terms "plurality" and "a plurality," as used herein, include, for example, "multiple" or "two or more." For example, "a plurality of wheels" includes two or more wheels.

The invention is not limited to specific types of string instruments, materials, or configurations, and the described mechanisms may be adapted to suit a variety of applications for producing bowed sound effects.

### Embodiments of the Present Invention

The present invention relates to a bow mechanism for string instruments, designed to facilitate continuous and controlled sound production through a rotating wheel with a circumferential layer. The mechanism enables musicians to achieve sustained, natural, and expressive tonal qualities by leveraging the interaction between the rotating wheel and the strings.

The bow mechanism comprises a wheel configured to rotate around a rotation axis and a circumferential layer characterized by elasticity encircling the wheel. The circumferential layer may include at least a first portion that is tightly secured around the outer circumference of the wheel and a second portion that extends outwardly from the first portion, forming a gap around the outer circumference. When the second portion is pressed against at least one string of a string instrument, the friction generated by the rotating wheel induces vibration in the string, thereby producing sound.

Unlike conventional bowing techniques that require manual bow movement, the mechanism provides consistent and uninterrupted bowing, offering new expressive possibilities for musicians. The system is designed to be adaptable to various string instruments, including violins, cellos, guitars, and other similar instruments. It can be incorporated into manual or motorized systems, allowing for both user-driven and automated bowing functionalities.

This novel approach overcomes the limitations of traditional bows by ensuring stable and repeatable bowing performance, reducing interruptions in sound production, and expanding the tonal capabilities of both bowed and non-bowed string instruments. By addressing the challenges outlined in the Background section, this invention enhances musical expression, enabling continuous, controlled, and versatile sound production across a variety of instruments.

### Preferred Embodiment

A preferred embodiment of the present invention may relate to a motorized bow mechanism for string instruments, comprising a shaft configured to be rotated by a rotation mechanism around a rotation axis, a wheel installed around said shaft having a diameter greater than the diameter of said shaft and configured to be rotated by said shaft around said rotation axis, said wheel comprises a rigid circumferential surface and an elastic circumferential layer disposed around said wheel. The elastic circumferential layer includes a first portion tightly secured around said rigid circumferential surface and a second portion, extending radially outward from said first portion to define a gap between said first portion and said second portion.

When activated, said second portion is configured to deform elastically toward said first portion when pressed against at least one string of a string instrument, such deformation being limited by said rigid circumferential surface beneath said first portion, thereby emulating the behavior of a string instrument bow.

The rotation of said wheel while said second portion is pressed against at least one string of a string instrument excites vibration of said at least one string to produce sound. This contact generates friction, inducing vibrations in the string that produce a continuous bowed sound.

The device is designed to provide musicians with a simple and efficient means of producing a bowed sound, allowing for precise control over the bowing process. By utilizing motorized rotation and elastic circumferential layer, the mechanism ensures reliable and high-quality sound generation on string instruments that effectively addresses the challenges described in the background chapter.

Various examples of the preferred embodiment may include different configurations of the motorized bow mechanism to accommodate a range of string instruments and playing styles. In one example, the wheel may be driven directly by an integrated motor, while in another, an intermediate gearing system may be utilized to adjust the rotation speed and torque applied to the wheel. Additionally, the circumferential layer may be made from different materials, such as synthetic polymers or natural fibers, to achieve varying levels of elasticity and friction. In some implementations, the second portion of the circumferential layer may have adjustable tension or thickness to modify the interaction with the string and optimize sound production.

Another example includes a system with two wheels holding the circumferential layer, where one of the wheels is connected to a manual or electric motor. In this configuration, the motorized wheel drives the circumferential layer, while the second wheel acts as a tensioning or guiding element, ensuring stable and even contact with the string. This setup allows for greater control over the movement of the circumferential layer, reducing fluctuations in pressure and improving sound consistency. Furthermore, the device may be designed as a handheld unit for versatile use across different instruments or integrated into a specific instrument as a built-in bowing mechanism. These variations allow the motorized bow to be adapted for different performance requirements while maintaining the core functionality of producing a continuous and controlled bowed sound.

Another preferred embodiment of the present invention relates to a bow mechanism for string instruments (101), wherein a circumferential layer encircles at least one wheel (106) and is configured to elastically retreat when pressed against a string (105). This design ensures continuous and controlled contact with the string while maintaining optimal friction and responsiveness for sound production.

The circumferential layer may be composed of specialized materials selected for their elasticity and friction properties, such as composite polymers, elastomeric compounds, or flexible treated wood. In some embodiments, the circumferential layer has a hair-like texture. This configuration ensures proper adhesion with rosin and enhances the bowing effect.

When the wheel (106) rotates, the circumferential layer engages the string, elastically retreating upon contact and returning to its original shape once the pressure is released. This mechanism allows for a natural stick-slip effect, mimicking traditional bowing techniques and enabling dynamic variations in tone and articulation.

The combination of an elasticity element with circumferential layer encircling at least one wheel (106), or a circumferential layer wrapped with natural or synthetic hair strands, allows musicians to achieve sharp and resonant sounds while maintaining the elastic principle of musical bows. This principle ensures sustained bowing with minimal unwanted noise, preventing the creaking or rigidity effects that may arise in less flexible bowing mechanisms.

### Other Embodiment

Any one or more of the following features, designs, and configurations can be incorporated into the invention described herein, independently or in combination:

### Configurations of the Wheel

Rigid Wheel: In one embodiment, the wheel is constructed from a rigid material, ensuring minimal deformation during rotation. The circumferential layer is securely attached to the wheel, maintaining consistent pressure and friction when engaged with a string.

This configuration enhances sound clarity and articulation, as the rigid wheel provides precise and stable contact with the string. The structural integrity of the wheel allows for uniform rotational motion, reducing unwanted variations in bowing pressure.

By utilizing a solid, non-compressible core, this embodiment ensures predictable and consistent bowing characteristics, making it ideal for musicians seeking a controlled and articulate sound output.

Removable Wheel: In one embodiment, the wheel is designed to be removable, allowing musicians to replace or modify the wheel based on their playing preferences. This configuration enables easy maintenance and customization, ensuring that the bow mechanism can adapt to different playing styles, tonal requirements, and string instrument types. A removable wheel also facilitates quick replacements in case of wear or damage, enhancing the device's longevity and usability.

Set of Replaceable Wheels: In a further embodiment, the bow mechanism includes a set of replaceable wheels, each featuring different diameters and/or widths. These variations allow musicians to fine-tune their bowing experience, as larger or wider wheels may provide greater contact area and stability, while smaller or narrower wheels may enable faster articulation and dynamic response.

The ability to swap between different wheel sizes and materials provides a customizable playing experience, catering to diverse performance styles, instrument types, and tonal characteristics.

All the following embodiments illustrate various configurations of the wheel structure, each designed to provide different degrees of elasticity. These configurations enhance the interaction between the bow mechanism and the string, ensuring optimal control over sound production, tonal quality, and dynamic response. By incorporating different materials and structural adaptations, the system allows for customizable bowing characteristics, catering to a wide range of playing techniques and instrument types.

Spiral-Structured Wheel: In one embodiment, the wheel features a spiral-shaped structure, where the circumferential layer varies in thickness, transitioning from highly flexible at one end to more rigid at the other.

This configuration allows users to achieve a broad spectrum of tonal qualities, ranging from soft, expressive sounds to sharper, more defined tones.

Layered Elastic Composition: In another embodiment, the wheel is composed of multiple elastic layers, where the flexibility of the outer layers gradually decreases toward the inner core.

This structure ensures adaptability across various string instruments and playing techniques, providing greater control over the interaction between the wheel or the circumferential layer and the string.

Liquid-Filled Composition: In yet another embodiment, the wheel includes a liquid-filled tire, enhancing string interaction by introducing compliance and damping properties.

The liquid inside the wheel provides a smoother grip and release cycle, producing a more refined, consistent bowed sound.

Polymeric Fluid Core: In a further embodiment, the wheel is made from a rigid material and fitted with a circumferential layer containing a low-density polymeric fluid capable of energy return.

This configuration improves grip on the string, ensuring a controlled release that enhances the natural bowing motion and sound continuity.

Air-Filled Tire Design: In another variation, the wheel is constructed with an air-filled plastic tire, providing enhanced flexibility and a cushioning effect.

This improves contact dynamics between the wheel or the circumferential layer and the string, allowing for smoother articulation and pressure adjustments during performance.

Solid Elastic Tire: In another embodiment, the wheel is made of a flexible solid material, similar to the composition of toy car tires, and does not contain air.

The inherent elasticity of the material provides optimal flexibility, ensuring a consistent and responsive bowing interaction with the string.

Spongy Contact Surface: In another embodiment, the wheel is made from a spongy material, which provides a soft, adaptable contact surface that dynamically adjusts to varying pressure during use.

This results in a smoother and more natural bowed sound, reducing unwanted frictional noise.

Honeycomb-Structured: In a further variation, the wheel is constructed using a honeycomb pattern, allowing the structure to maintain elasticity while ensuring improved flexibility and resilience.

The geometric design distributes force evenly, enhancing the wheel’s responsiveness to string pressure changes.

Internal Spring Mechanism: In yet another embodiment, the wheel incorporates an internal spring mechanism that provides additional elasticity and controlled resistance.

This feature optimizes the grip and release interaction with the string, ensuring more precise dynamic control over sound production.

These various embodiments offer enhanced adaptability, customized playing experiences, and greater tonal control, making the bow mechanism suitable for a wide range of string instruments and performance styles.

### Configurations of the Circumferential Layer

The circumferential layer surrounding the wheel may be made from a material that is softer than the wheel itself, with variations in length, thickness, and shape that influence flexibility, string interaction, and resulting tonal qualities. Additional textured surfaces, such as fine straight grooves, may be incorporated to optimize rosin absorption for enhanced friction and tonal richness.

Narrow Circumferential Layer: In one embodiment, the second portion of the circumferential layer is narrow, making it stiffer and slightly more springy. This configuration sharpens the tonal output, producing a more powerful and focused sound. The primary contact points with the string occur at the tip of the second portion, which is narrow at the string-contacting end and tapers downward at the opposite end.

Circumferential Layer with Integrated Plectrums: In another embodiment, the second portion of the circumferential layer features small plectrums attached to its surface, generating a tremolo effect as the wheel rotates against the string. The contact points with the string are at the plectrums, and the overall shape of the second portion remains narrow at the contact point while tapering downward on the opposite side.

Long and Flexible Circumferential Layer: In yet another embodiment, the second portion of the circumferential layer is longer and softer, resulting in greater flexibility and a gentler interaction with the string. This design produces a softer, more delicate sound. The contact points with the string extend from the tip to the central portion of the circumferential layer, which slopes downward. The overall shape is wider compared to the narrow configuration, allowing both the sharp tip and the downward-sloping central section to engage with the string.

Curved Circumferential Layer: In another embodiment, the second portion of the circumferential layer adopts a curved shape, balancing softness and structural rigidity. This design enhances stiffness while preserving a larger contact area with the string. The contact points occur from the tip to both sloped sides, ensuring a consistent bowing interaction. The cross-sectional shape is parabolic, allowing both the peak and the downward slopes to engage with the string.

Vase-Shaped Circumferential Layer: In a further embodiment, the circumferential layer has a vase-like shape, resembling a tire structure. This design focuses the applied pressure at the center of the wheel, ensuring better balance and control. The contact points with the string occur between the tip and the descending and ascending slopes. The cross-section features a parabolic-wavy structure, with rising and falling curves similar to the contours of a vase, allowing the string to engage with both the peak and the slopes.

Double Narrow Circumferential Layer: In another embodiment, the circumferential layer is designed as a single integrated unit with internal cavities that enhance flexibility and allow controlled deformation when pressed against a string. The outer section is structured for direct contact with the string, optimizing friction, energy transfer, and vibration induction for improved sound production. This design balances structural rigidity with elasticity, ensuring that the circumferential layer adapts dynamically to string pressure while maintaining consistent and stable bowing interaction. The narrow structure allows for precise control over the contact points, enhancing articulation and tonal quality.

These variations in circumferential layer design allow for customizable playability, enabling musicians to achieve diverse tonal effects while maintaining consistent, controlled bowing interactions with string instruments.

### Hair-Wrapped Circumferential Layer

In one embodiment, the circumferential layer is wrapped with natural or synthetic hair strands, similar to traditional bow hair used in string instruments. The hair strands are evenly distributed and tightly wound around the second portion of the circumferential layer, ensuring consistent friction and optimal interaction with the string.

To secure the hair, the beginning and end of each strand are:

[a] Interwoven with adjacent strands, creating a self-locking mesh that prevents unraveling.

[b] Anchored to the wheel or circumferential layer, ensuring firm attachment and stability.

[c] Pressed or bonded to the circumferential layer using a tension-locking mechanism, ensuring uniform distribution.

This configuration allows the hair-wrapped circumferential layer to mimic the stick-slip effect found in traditional bowing, producing a warm, resonant tone with natural articulation. The use of natural horsehair enhances rosin absorption, while synthetic hair offers increased durability and resistance to environmental changes.

By incorporating hair wrapping techniques, this embodiment enables a more expressive and customizable bowing experience, expanding the tonal possibilities for musicians using the electric bow mechanism.

In some embodiments, the circumferential layer or the wheel may feature different surface textures to optimize interaction with the string. These textures can include a smooth surface, a roughened texture, or grooved patterns that mimic the structure of the hair-wrapped circumferential layer. A smooth surface provides consistent contact and even friction distribution, while a rough or textured surface enhances grip and increases friction, improving the bowing effect. Additionally, grooved patterns can simulate the natural texture of tightly wound hair strands, ensuring improved rosin retention and controlled interaction with the string. By incorporating these variations, this embodiment allows for further customization of bowing characteristics, enabling musicians to achieve different tonal qualities and playing dynamics.

### Manual Mechanism for the Bow Mechanism

In some embodiments, the wheel of the bow mechanism for string instruments is driven by a manual mechanism instead of an electric motor. This design allows musicians to operate the mechanism without reliance on electrical power, offering greater portability, control, and adaptability for various playing styles.

Hand-Cranked Rotation Mechanism: In one embodiment, the wheel is rotated manually using a hand-crank mechanism. The crank handle is positioned on the side of the device, enabling the musician to rotate the wheel at a controlled speed while engaging the second portion of the circumferential layer with the string. This design allows for precise bowing techniques, as the musician can dynamically adjust the rotation speed to influence the intensity and sustain of the produced sound.

Finger-Operated Wheel Control: In another embodiment, the wheel is equipped with a finger-driven control surface, allowing the musician to directly spin the wheel using their thumb or fingers. This configuration provides immediate tactile feedback, enabling fine-grained control over bowing pressure and speed. The circumferential layer retains its dual-portion design, where the first portion remains secured to the wheel while the second portion extends outwardly to engage the string.

Spring-Assisted Manual Rotation: In a further embodiment, the wheel incorporates a spring-assisted mechanism that helps maintain consistent rotational motion with minimal manual input. The spring mechanism stores rotational energy when the wheel is turned manually and gradually releases it to provide a smooth and continuous bowing motion. This design reduces player fatigue while ensuring a steady and uninterrupted sound output.

Gear-Based Mechanical Drive: In another embodiment, a gear-based manual drive system is integrated into the mechanism. The musician operates a small gear wheel, which transmits motion through a series of interlocking gears to rotate the bowing wheel. The gear ratios can be adjusted to modify the speed and resistance, allowing precision control over the bowing effect.

String-Pulled Rotation Mechanism: In another variation, the wheel is rotated via a pull-string mechanism, similar to a yo-yo or toy gyroscope. The musician pulls a retractable string, which spins the wheel for a predefined duration before requiring another pull. This method enables short bursts of sustained bowing, making it useful for short phrases or accentuated notes.

These manual embodiments provide alternative ways to operate the bow mechanism, catering to musicians who prefer non-electric solutions while maintaining the core functionality of a rotating wheel and circumferential layer for effective bowed sound production.

### Rosin Application Mechanism

In some embodiments, the circumferential layer may be coated with rosin to enhance adhesion and friction with the string, optimizing sound production. The controlled interaction between the rotating wheel and the string allows for a sustained and consistent bowed effect, simulating the natural articulation of a traditional bow.

In some embodiments, a rosin application mechanism is integrated into a mounting system attached to the string instrument, providing automatic and controlled rosin application to the bow mechanism. This system ensures consistent friction enhancement while allowing for improved playability and hands-free operation.

Automated rosin application mechanism: The rosin application system consists of a fixed apparatus mounted onto the string instrument, designed to periodically bring a rosin block into contact with the second portion of the circumferential layer. This enables:

[a] Automatic rosin replenishment without requiring manual intervention.

[b] Controlled engagement, ensuring the rosin is applied only when needed based on specific parameters, such as: Wheel rotations, Contact duration with the string, Friction levels and resistance measurements.

Fixed mounting system for the device: In another embodiment, the bow mechanism is mounted onto a dedicated fixture attached to the string instrument. This mounting system provides enhanced stability and greater freedom of movement for the musician by offering the following functionalities:

[a] Fixed Attachment to the Instrument – The mounting system is securely attached to the instrument’s body, ensuring consistent positioning for optimal interaction with the strings.

[b] Detachable Device Integration – The bow mechanism can be firmly secured to the mounting system, allowing easy attachment and detachment when needed.

[c] Free Motion Across Strings – The mounting system allows the musician to move the bow mechanism freely across different strings, enabling both playing and stopping the sound dynamically by shifting positions.

[d] Hands-Free Continuous Bowing – In an advanced configuration, the system allows the musician to lock the bow mechanism onto a specific string, where it continuously vibrates the string without requiring the musician to hold the device. This allows for: Sustained, uninterrupted sound production on one or more strings or Simultaneous playing of other instrument parts while the mounted bowing mechanism remains active.

By integrating these features, the automated rosin application system and fixed mounting configuration provide musicians with a seamless, hands-free playing experience, enabling greater tonal control, precision, and dynamic flexibility in performance.

### Hand-Held Electric Bow Device

In some embodiments, the bow mechanism is integrated into a hand-held electric bow device designed for string instruments. This configuration allows musicians to operate the bow mechanism independently from the instrument, providing greater maneuverability and dynamic control over the bowing process.

The hand-held design ensures that the musician can position and adjust the interaction between the circumferential layer and the string with precision, enabling a wide range of articulation techniques such as legato, spiccato, and controlled dynamic transitions.

In a further embodiment, the hand-held device includes a handle, improving grip, comfort, and stability during use. The handle is designed to:

[a] Provide ergonomic support, ensuring ease of handling during extended playing sessions.

[b] Facilitate controlled movement, allowing precise adjustments of the bowing angle and pressure.

[c] Enhance portability, making the electric bow mechanism easy to use across different string instruments.

The handle may be designed with adjustable grip sizes, allowing for customization based on player preference. Additionally, it may be made from lightweight materials to prevent fatigue while maintaining structural integrity and durability.

By integrating these features, the hand-held electric bow device provides musicians with a versatile, user-friendly, and expressive tool for enhancing bowed string performance.

### Other Embodiments

In some embodiments, the circumferential layer of the bow mechanism is designed to enhance interaction with the strings of a string instrument through its structural composition and material properties. The outer surface of the circumferential layer may comprise a texture resembling the texture of hair, mimicking the surface characteristics of traditional violin bow hair.

Furthermore, the circumferential layer is characterized by elasticity, enabling it to deform when pressed against a string and return to its original shape when the pressure is released.

To further refine the functionality of the bow mechanism, external shock absorbers may be incorporated into the design. These shock absorbers serve to enhance the flexibility of the circumferential layer, reducing unwanted vibrations and ensuring smooth, controlled interaction with the string. By absorbing excess energy and allowing for gradual pressure adjustments, the shock absorbers contribute to a more stable and responsive bowing experience.

In some embodiments, the bow mechanism incorporating two wheels can be implemented, wherein the circumferential layer is wrapped around both wheels. The gap between the two wheels introduces elasticity to the circumferential layer, allowing it to deform when pressed against at least one string and return to its original shape when the pressure is released. This design enhances the bowing mechanism’s flexibility, ensuring consistent pressure distribution and smooth interaction with the string. The ability of the circumferential layer to dynamically adjust its shape optimizes sound production by maintaining stable contact with the string while minimizing unwanted frictional resistance.

### SUMMARY

In summary, the bow mechanism described provides an innovative and adaptable solution for sound production on string instruments. By utilizing a rotating wheel with a circumferential layer, the mechanism enables continuous, controlled, and expressive bowing, overcoming the limitations of traditional bows. The system is designed to accommodate both motorized and manual drive mechanisms, allowing for greater flexibility, portability, and user control.

The invention introduces various structural enhancements, including alternative wheel and circumferential layer configurations, enabling customization of tonal qualities, friction dynamics, and responsiveness. These configurations include textured surfaces for optimized rosin absorption, flexible and rigid material variations, and structural designs such as honeycomb patterns, spring-assisted layers, and liquid-filled components.

Additionally, the bow mechanism is compatible with a wide range of string instruments, including violins, cellos, guitars, and harps, and offers features such as easy wheel replacement, customizable stiffness levels, and enhanced interaction between the circumferential layer and the string.

By integrating manual drive options, such as hand-cranks, foot pedals, gear-based drives, and spring-assisted rotation mechanisms, the system provides alternative power sources for musicians seeking greater control and independence from electrical components.

This invention significantly enhances musical performance capabilities, allowing for sustained, uninterrupted sound production while expanding the expressive potential of both bowed and non-bowed string instruments. The versatility of the bow mechanism makes it a valuable tool for musicians, instrument designers, and performers seeking innovative bowing techniques and sound possibilities.

Various objects, features, and aspects of the present invention will become more apparent from the following description of the drawings of the invention, along with the accompanying figures, in which numerals represent like components.

### BRIEF DESCRIPTION OF THE DRAWINGS

The disclosure can be more fully appreciated in connection with the following detailed description, taken in conjunction with the accompanying drawings, which:

FIG. 1 illustrates a preferred configuration of the device in use with a string instrument.

FIG. 2A illustrates a cross-sectional view of a possible configuration of the preferred embodiment.

FIG. 2B illustrates the 3D structure of the circumferential layer, showing the gap between the first portion and the second portion.

FIGS. 2C illustrate the elasticity of the circumferential layer.

FIG. 3A illustrates a possible configuration of the preferred embodiment, wherein the wheel is designed with a spiral structure that provides flexibility, allowing it to deform under pressure and return to its original shape. Additionally, the figure illustrates a configuration in which a motor is located inside the handle and drives the rotation of the wheel.

FIG. 3B illustrates a possible configuration of the preferred embodiment, wherein the device includes external shock absorbers that enhance flexibility.

FIG. 3C illustrates a cross-sectional view of a possible configuration of the preferred embodiment, wherein the device includes two wheels, with the circumferential layer wrapped around both. The inner ring surrounding both wheels illustrates the first portion, while the outer ring surrounding both wheels illustrates the second portion.

FIG. 4A illustrates a preferred configuration where the wheel and circumferential layer are a single unit, with elasticity provided by a spring in the handle.

FIG. 4B illustrates a cross-sectional view of a preferred configuration where two wheels are present, with the circumferential layer wrapped around both.

FIG. 4C illustrates a preferred configuration where the wheel and circumferential layer are a single unit, with elasticity enabled by the internal structure of the wheel.

FIG. 5 illustrates a cross-sectional view of a manual operation configuration without an electric motor.

FIG. 6A illustrates the application of rosin to the circumferential layer.

FIG. 6B illustrates a cross-sectional view of an automatic mechanism for applying rosin to the wheel.

FIGS. 7A-7B illustrate a flexible spiral-structured wheel in its normal state and under pressure.

FIG. 8A illustrates a spiral-structured wheel made of plastic, where the spiral has a thin thickness allowing for high flexibility.

FIG. 8B illustrates a spiral-structured wheel made of plastic, where the spiral has a medium thickness allowing for moderate flexibility.

FIG. 8C illustrates a solid plastic wheel, which allows for low flexibility.

FIG. 8D illustrates a wheel with an internal honeycomb structure, where the flexibility is determined by the size of the polygons forming the structure.

FIGS. 9A illustrate different circumferential layer configurations, including Narrow Circumferential Layer, Circumferential Layer with Integrated Plectrums, Long and Flexible Circumferential Layer, Curved Circumferential Layer, Vase-Shaped Circumferential Layer, And Double Narrow Circumferential Layer.

FIG. 9B illustrates the point of contact between the string and the circumferential layer.

FIG. 10 illustrates a configuration where the wheel or circumferential layer has a texture similar to violin bow hair, with a close-up of the fibers.

FIG. 11A illustrates a cross-section of a configuration where the wheel and the circumferential layer are formed as a single unit.

FIG. 11B illustrates a cross-section of a configuration where the wheel and the circumferential layer are formed as a single unit, with the additional option of wrapping hair around the expanding section to simulate the texture of a violin bow.

FIG. 11C, illustrates a cross-section view of a configuration where the Honeycomb-Structured wheel and the Double Narrow Circumferential Layer are formed as a single unit.

These figures, when considered together with the detailed description, provide a comprehensive understanding of the structure and functionality of the invention.

### DETAILED DESCRIPTION OF THE DRAWINGS

### General Comments

The present invention will be understood from the following detailed description of the drawings, which are meant to be descriptive and not limiting. For the sake of brevity, some well-known features, methods, systems, procedures, components, and so on, are not described in detail.

### Description of the Drawings

The accompanying drawings illustrate various components and mechanisms of the system.

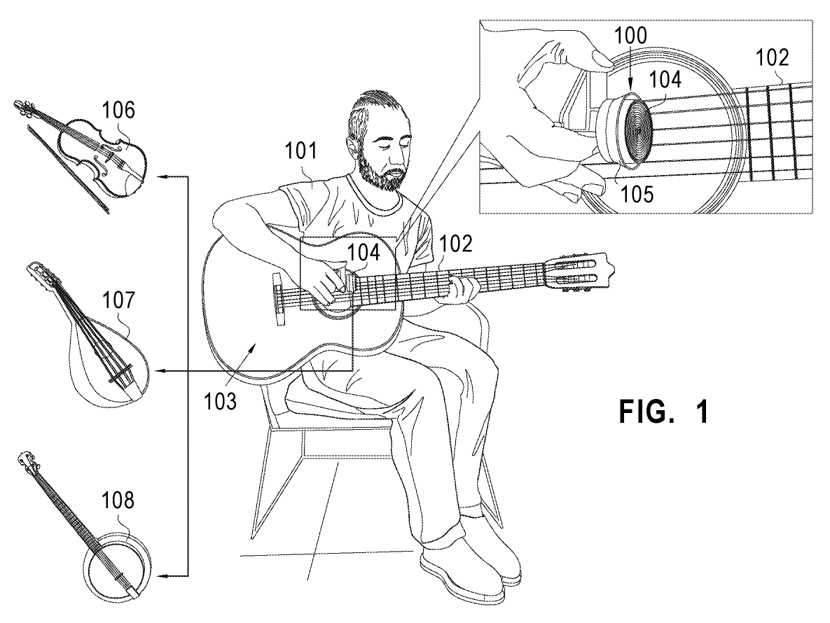

Turning first to FIG. 1, which illustrates a preferred configuration of a bow mechanism (100) for string instruments (106, 107, 108) in use. The figure provides an example of how a person (101) operates the device to play a guitar (103), demonstrating the interaction between the bow mechanism and the strings of the instrument.

The mechanism includes a wheel (104) designed to rotate around a rotation axis. Encircling the wheel is a circumferential layer (105), which engages with the instrument’s strings (102) to produce sound. The circumferential layer (105) consists of at least two portions: a first portion, which is tightly secured around the outer circumference of the wheel, and a second portion, which extends outwardly from the first portion, forming a gap around the wheel’s outer circumference.

During operation, the rotation of the wheel while the second portion of the circumferential layer is pressed against at least one string of the guitar causes the string to vibrate and produce sound. The flexibility and material properties of the circumferential layer enhance the bowing effect, ensuring smooth and controlled interaction with the string.

The circumferential layer is designed with elastic properties, allowing it to deform when pressed against the string and return to its original shape when the pressure is released. This elasticity ensures optimal friction and smooth bowing motion, improving sound quality and responsiveness.

FIG. 1 further illustrates how the bow mechanism is used in a real-world setting, showing a person holding and operating the device while playing a guitar. This depiction highlights the ergonomic design of the mechanism, allowing the musician to control bowing pressure and movement with precision. The handheld nature of the device ensures ease of use and maneuverability, making it adaptable to different playing techniques and musical expressions.

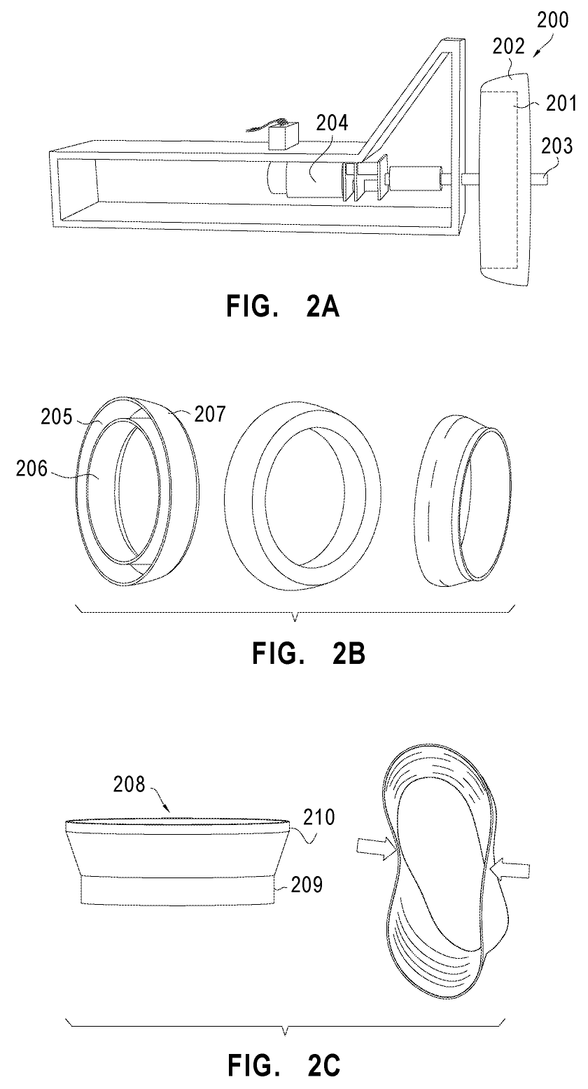

Now referring to FIG. 2A, which illustrates a possible configuration of the preferred embodiment of a bow mechanism (200) for string instruments. The figure shows a wheel (201) rotating around a rotation axis (203), with a circumferential layer (202) encircling the wheel. The first portion of the circumferential layer is tightly secured around the wheel, while the second portion extends outward, forming a gap that interacts with at least one string to produce sound.

FIG. 2A further illustrates that the wheel is operatively connected to a motor (204), which drives its rotation. This motorized mechanism ensures continuous and controlled bowing, providing consistent engagement with the string. The elastic properties of the circumferential layer enhance friction and responsiveness, simulating traditional bowing techniques.

By integrating motorized operation with an elastic circumferential layer, the configuration is illustrated in FIG. 2A enables automated and precise bowing, enhancing consistency, control, and expressiveness in playing string instruments.

Referring now to FIG. 2B, which illustrates the three-dimensional structure of the circumferential layer. The figure highlights the gap (205) between the first portion (206), which is secured tightly around the wheel, and the second portion (207), which extends outward. This structural configuration allows the second portion to flex upon contact with a string, optimizing friction and responsiveness for effective sound production.

Referring now to FIG. 2C , which illustrates the elasticity of the circumferential layer (208). The figure demonstrates how the entire circumferential layer is made of an elastic material, allowing both the first portion (209) to remain tightly secured to the wheel and the second portion (210) to flex when pressed against a string. This structural elasticity ensures secure attachment to the wheel while enabling controlled deformation of the second portion, optimizing friction and sound production.

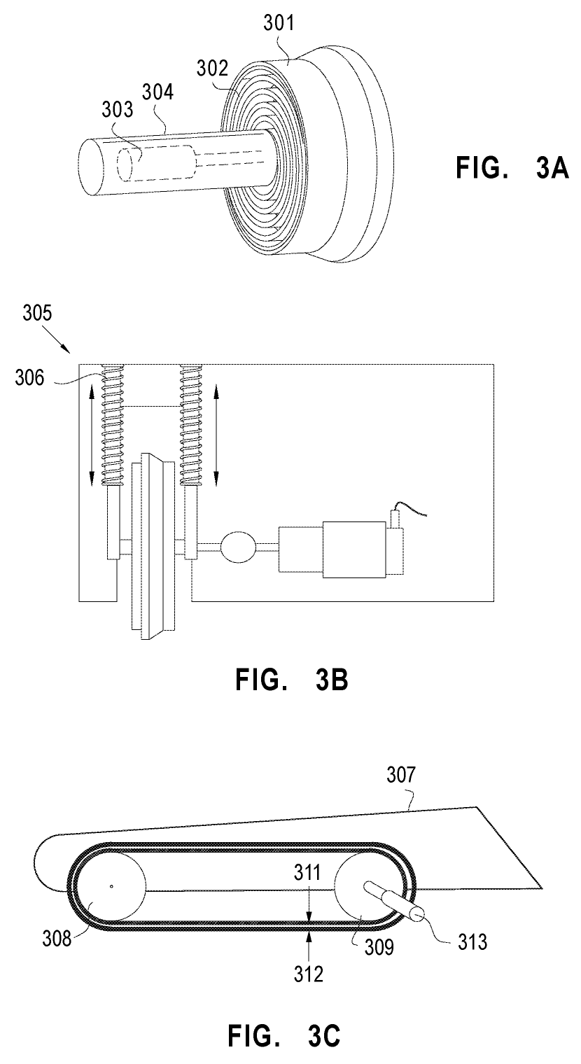

Referring now to FIGS. 3A-3C, which illustrate different configurations of the bow mechanism’s flexibility and structural adaptations.

FIG. 3A depicts a configuration where the wheel (301) is designed with a spiral structure (302) that enhances flexibility, allowing it to deform under pressure and return to its original shape. Additionally, the figure shows a configuration where a motor (303) is housed inside the handle (304), providing rotational movement to the wheel.

FIG. 3B illustrates a configuration where the device (305) includes external shock absorbers (306) that further enhance the flexibility of the circumferential layer, ensuring controlled deformation and improved interaction with the string.

FIG. 3C presents a cross-sectional view of a configuration where the device (307) includes two wheels (308, 309), with the circumferential layer wrapped around both (311, 312). The inner ring (311) surrounding both wheels represents the first portion, while the outer ring (312) represents the second portion. The wheels rotate via the movement of a rotating shaft (313), ensuring smooth and responsive bowing operation.

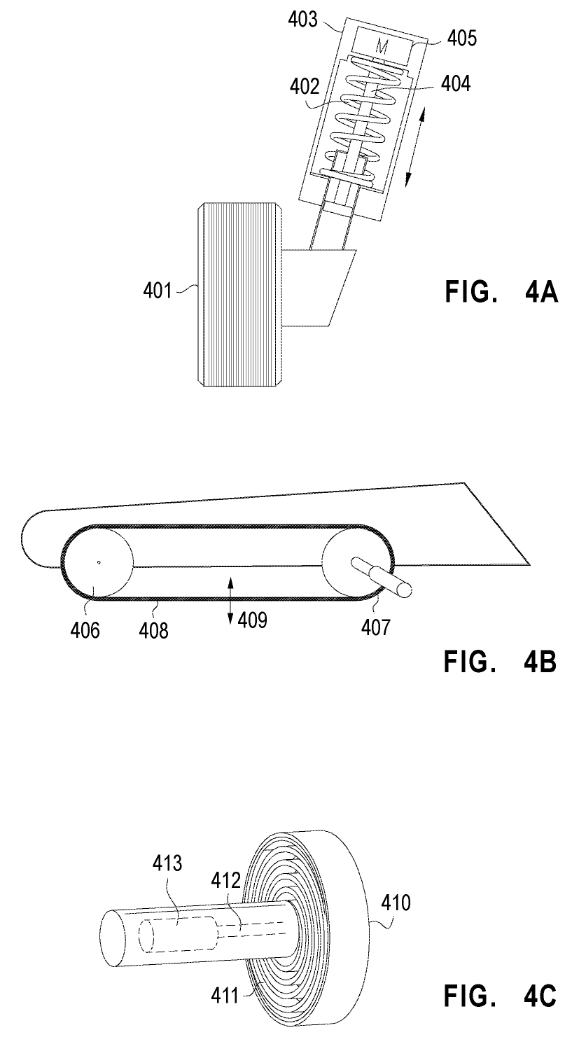

Referring now to FIGS. 4A-4C, which illustrate different configurations of wheel elasticity in the bow mechanism.

FIG. 4A depicts a configuration where the wheel and circumferential layer form a single unit (401), with elasticity provided by a spring (402) located inside the handle (403). The handle also houses the shaft (404) that rotates the wheel and the motor (405).

FIG. 4B presents a cross-sectional view of a configuration featuring two wheels (406, 407), with the circumferential layer wrapped around both (408). The gap between the two wheels provides elasticity (409), allowing the circumferential layer to deform upon contact with a string and return to its original shape once the pressure is released.

FIG. 4C illustrates a preferred configuration where the wheel and circumferential layer form a single unit (410), with elasticity provided by the internal structure of the wheel (411). Similar to FIG. 4A, the handle houses the rotating shaft (412) and motor (413), ensuring smooth and controlled bowing operation.

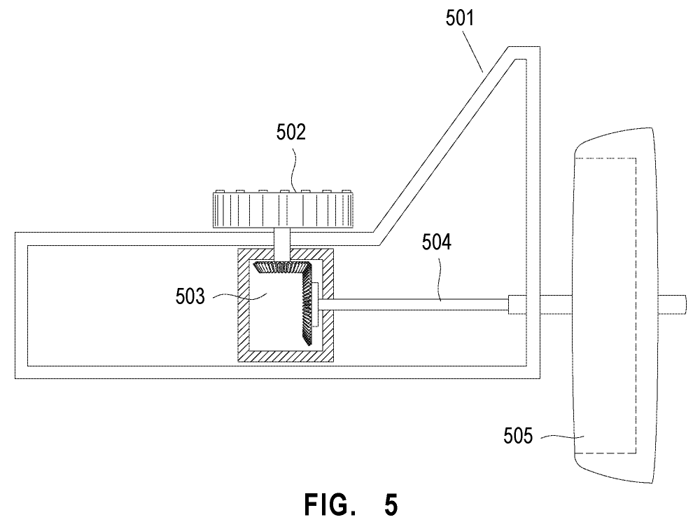

Referring now to FIG. 5, which illustrates a cross-sectional view of a manual operation configuration (501) without an electric motor. The figure demonstrates how the wheel (505) is rotated by a manual mechanism (503), operated through the rotation of a knob (502). Turning the knob activates a gear system (503), which in turn drives a shaft (504). The movement of the shaft transmits rotational force to the wheel (505), allowing for controlled manual operation of the bow mechanism.

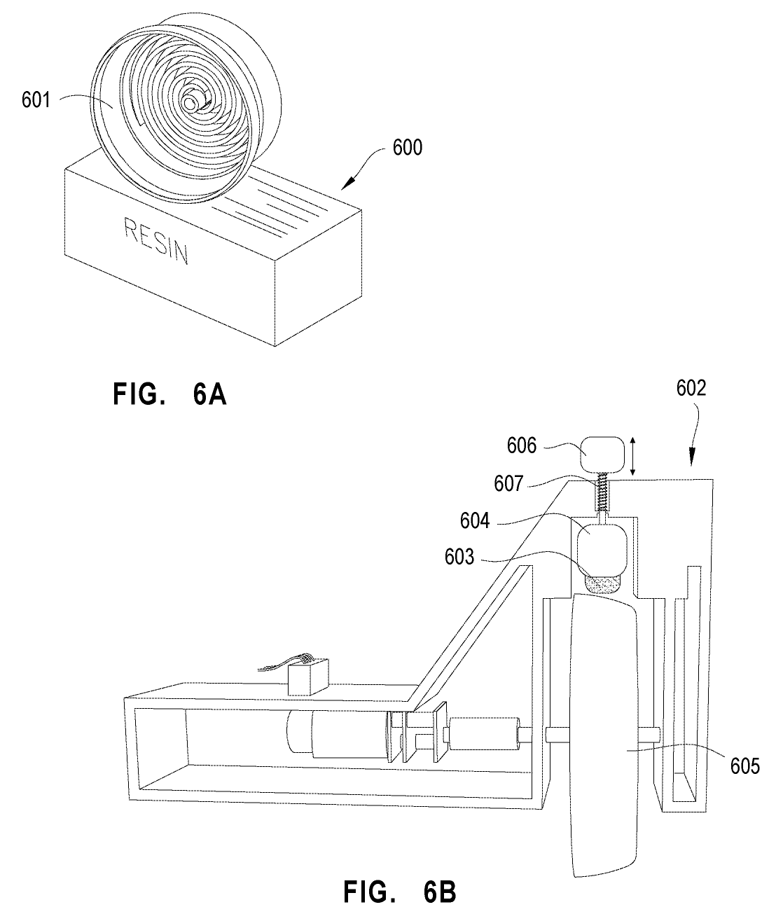

Referring now to FIGS. 6A-6B, which illustrate different methods for applying rosin to the circumferential layer. FIG. 6A depicts the manual application of rosin (600) to the circumferential layer (601), enhancing adhesion and friction between the bow mechanism and the string. FIG. 6B presents a cross-sectional view of an automatic mechanism (602) for applying rosin (603) to the wheel. The system includes a mounting member (604) designed to hold a block of rosin (603), which can be positioned either in contact with the circumferential layer (605) or away from it. Rotation of the wheel while the rosin block is engaged (606) enables consistent coating of the circumferential layer. Additionally, the system may include a spring (607) that automatically moves the rosin block away when pressure on a button (606) is released, ensuring controlled application and preventing unnecessary wear.

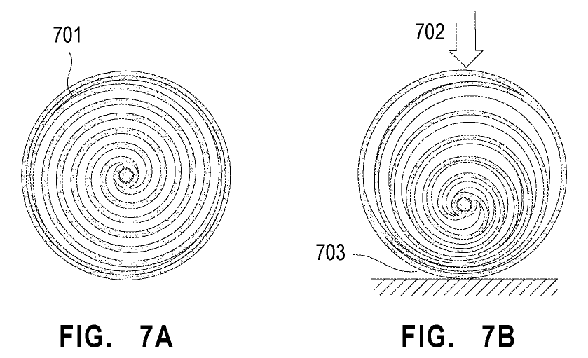

Referring now to FIGS. 7A-7B , which illustrate the flexibility of a spiral-structured wheel (701, 702). The figures demonstrate how the wheel is designed with a spiral structure, allowing it to deform under the pressure of the string (703) and return to its original shape when the pressure is released. This structural elasticity enhances the adaptability of the circumferential layer, ensuring optimal friction and controlled interaction with the string for improved sound production

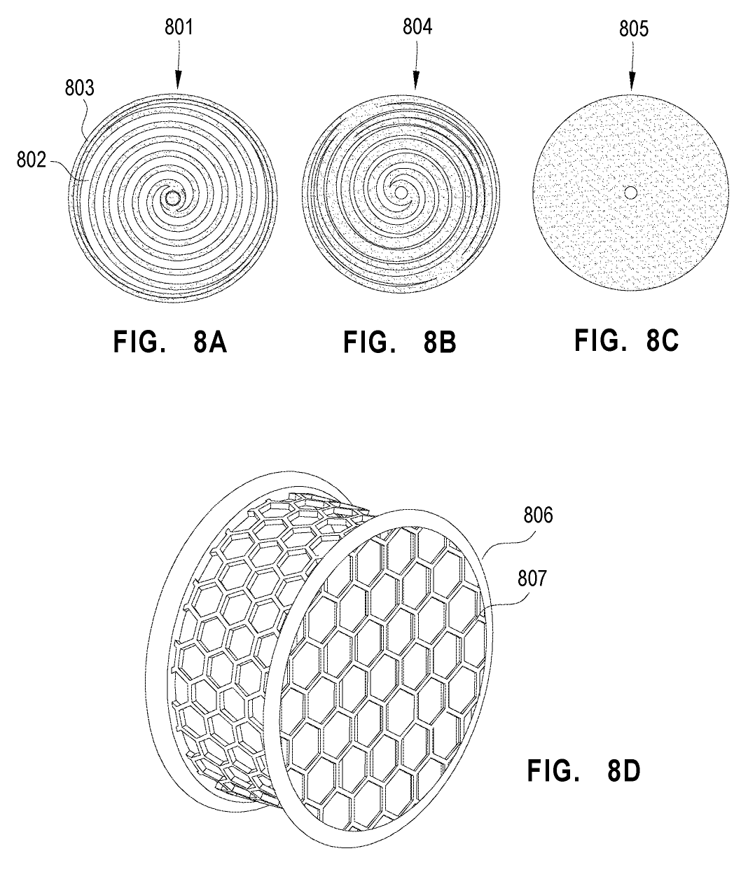

Referring now to FIGS. 8A-8C, which illustrates different configurations of a spiral-structured wheel made of plastic with varying levels of flexibility. FIG. 8A illustrates a thin spiral-structured wheel (801), where the spiral slits (802) extend from the rotation axis toward the outer circumference (803), allowing for high flexibility. FIG. 8B illustrates a medium-thickness spiral-structured wheel (804), which provides moderate flexibility. FIG. 8C illustrates a solid plastic wheel (805), which allows for low flexibility due to the absence of structural adaptations. These configurations demonstrate how different structural designs of the wheel can influence the elasticity of the circumferential layer, optimizing its interaction with the string to enhance sound production.

Referring now to FIG. 8D, which illustrates a wheel (806) with an internal honeycomb structure (807). The figure demonstrates how the flexibility of the wheel is determined by the size of the polygons forming the honeycomb pattern. This structural design allows the wheel to maintain strength while providing controlled elasticity, optimizing the interaction between the circumferential layer and the string to enhance sound production.

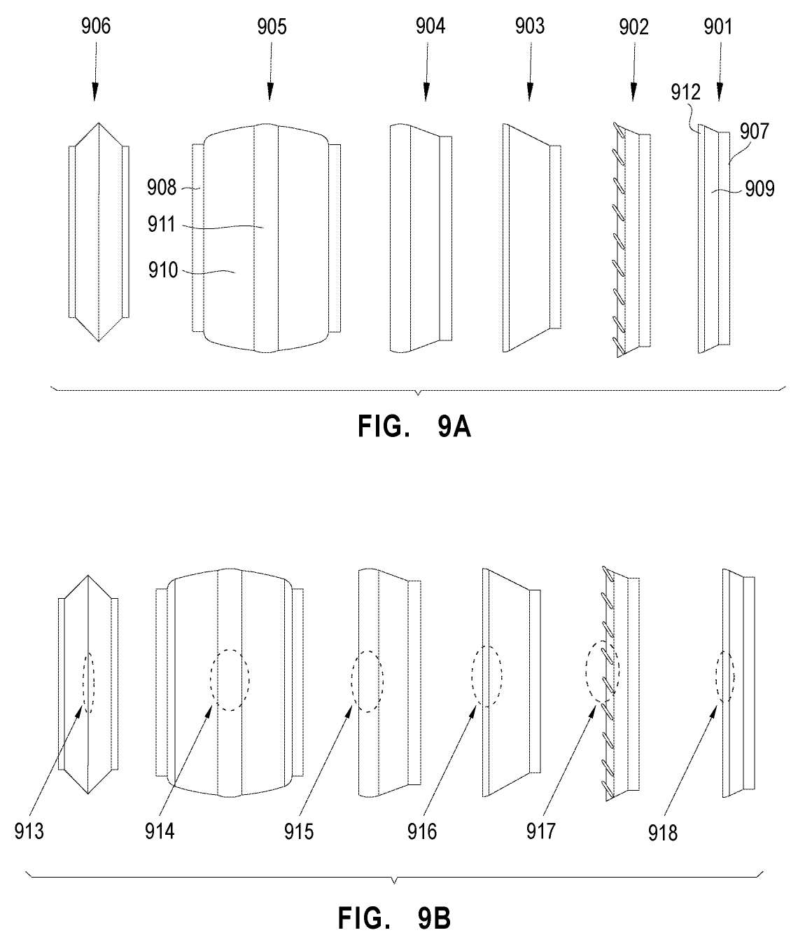

Referring now to FIG. 9A, which illustrates different circumferential layer configurations, including Narrow Circumferential Layer (901), Circumferential Layer with Integrated Plectrums (902), Long and Flexible Circumferential Layer (903), Curved Circumferential Layer (904), Vase-Shaped Circumferential Layer (905), and Double Narrow Circumferential Layer (906). The figure further demonstrates how the first portion (907, 908) is secured tightly around the outer circumference of the wheel, while the second portion (912-911, 909-910) may include longitudinal protrusions and/or grooves around its outer circumference. These variations in structural design allow for different levels of flexibility and friction control, optimizing the interaction between the bow mechanism and the string to enhance sound production.

Referring now to FIG. 9B , which illustrates the point of contact between the string and the circumferential layer (913-918). The figure demonstrates the specific area where the string engages with the circumferential layer, ensuring controlled friction and efficient energy transfer.

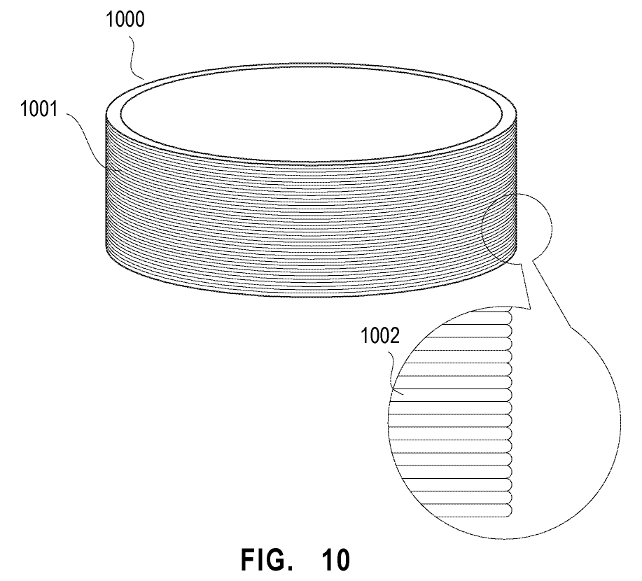

Referring now to FIG. 10, which illustrates a configuration where the wheel or circumferential layer (1000) features a texture resembling violin bow hair (1001). The figure further includes a close-up view of the fibers (1002), demonstrating how the textured outer surface of the circumferential layer enhances friction and interaction with the string. This hair-like texture optimizes grip, ensuring effective sound production by mimicking the natural properties of traditional bow hair.

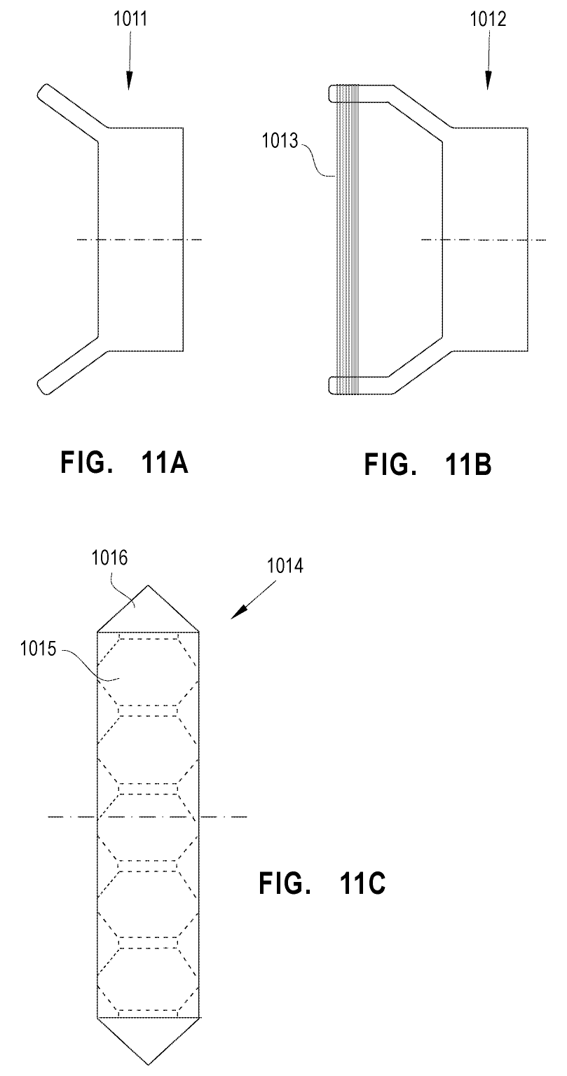

Referring now to FIGS. 11A-11B, which illustrate cross-sectional views of different configurations of the wheel and circumferential layer. FIG. 11A depicts a configuration where the wheel and the circumferential layer are formed as a single unit (1011). FIG. 11B illustrates a similar configuration (1012) but with the additional option of wrapping hair around the expanding section (1013) to simulate the texture of a violin bow, enhancing friction and optimizing sound production.

Referring now to FIG. 11C, which illustrates a cross-sectional view of the Double Narrow Circumferential Layer (1014). This component is formed as a single integrated unit where the circumferential layer includes internal cavities (1015) designed to provide flexibility and controlled deformation when pressed against a string. The outer section (1016) is structured to engage directly with the string, ensuring optimal friction and energy transfer to induce vibrations and produce sound.

The content described above is illustrative and should not be seen as restrictive. Various alterations and changes can be made without deviating from the true spirit and scope of the present invention, which is defined in the subsequent claims.

What is claimed:

1. A bow mechanism for string instruments, comprising:
a shaft configured to be rotated by a rotation mechanism around a rotation axis;
a wheel installed around said shaft, having a diameter greater than the diameter of said shaft and configured to be rotated by said shaft around said rotation axis, wherein said wheel comprises a rigid circumferential surface;
an elastic circumferential layer disposed around said wheel, wherein said elastic circumferential layer comprises at least:
a first portion secured tightly around said rigid circumferential surface;
a second portion extending radially outward from said first portion to define a gap between said first portion and said second portion;
wherein said second portion is configured to deform elastically toward said first portion when pressed against at least one string of a string instrument, such deformation being limited by said rigid circumferential surface beneath said first portion, thereby emulating the behavior of a string instrument bow; and
wherein rotation of said wheel while said second portion is pressed against at least one string of a string instrument excites vibration of said at least one string to produce sound.

2. The mechanism of claim 1, wherein said elastic circumferential layer has a hair-like texture.

3. The mechanism of claim 1, wherein said wheel is operatively connected to a motor configured to generate rotational movement for rotating said wheel.

4. The mechanism of claim 3, wherein, upon activation of the motor, the wheel rotates, and the elastic circumferential layer, being coated with rosin, interacts with the string to produce vibrations by adhering to, gripping, and releasing the string in a manner that mimics the stick-slip effect of a traditional bow, thereby producing a clear and natural bowed string sound.

5. The mechanism of claim 1, wherein said second portion is configured to be pushed inwardly toward said rigid circumferential surface of said wheel when pressed against said least one string of said string instrument.

6. The mechanism of claim 1, wherein said wheel comprises at least one of the following structural adaptations to provide varying degrees of elasticity: a spiral-structured wheel, a layered elastic composition, a liquid-filled composition, a polymeric fluid core, an air-filled tire design, a solid elastic tire, a spongy contact surface, a honeycomb-structured layer, or an internal spring mechanism.

7. The mechanism of claim 1, wherein said wheel comprises a plurality of slits spirally extending from the rotation axis of said wheel toward said rigid circumferential surface.

8. The mechanism of claim 1, wherein said second portion comprises a plurality of longitudinal protrusions and/or grooves around an outer circumference of said second portion.

9. The mechanism of claim 1, wherein said elastic circumferential layer is removable.

10. The mechanism of claim 1, wherein said wheel and said elastic circumferential layer are formed as one piece.

11. The mechanism of claim 1, wherein said second portion comprises a plurality of strands of hair wrapped around an outer circumference of said second portion.

12. The mechanism of claim 1, wherein said elastic circumferential layer is wrapped with natural or synthetic hair strands, wherein said hair strands are tightly wound around said second portion and secured by interweaving with adjacent strands, anchoring to said wheel or said elastic circumferential layer, or using a tension-locking mechanism.

13. The mechanism of claim 1, wherein said wheel is configured to be rotated by a manual mechanism.

14. The mechanism of claim 1, wherein said elastic circumferential layer is configured to be coated with rosin to increase adhesion and friction with said at least one string.

15. The mechanism of claim 1, further comprising a rosin mounting member configured to hold a block of rosin in at least one position in contact with said elastic circumferential layer, wherein rotation of said wheel while said block of rosin is held in said at least one position, causes said block of rosin to coat said elastic circumferential layer with rosin, and wherein said mounting member is further configured to hold said block of rosin in a position with no contact with said elastic circumferential layer.

16. The mechanism of claim 15, wherein said positioning mechanism is automated and configured to periodically toggle said rosin mounting member between said at least one position in contact with said elastic circumferential layer and said position with no contact with said elastic circumferential layer based on at least one of the following parameters: motor activation time, number of rotations of said wheel, number of rotations of said wheel while in contact with at least one string, amount of rosin of said elastic circumferential layer, weight of said circumferential layer or wheel, amount of resistance formed during interaction between said elastic circumferential layer and said at least one string.

17. The mechanism of claim 1, wherein an outer surface of said elastic circumferential layer comprises a texture resembling the texture of hair.

18. The mechanism of claim 1, wherein elasticity of said elastic circumferential layer is allowing said second portion to deform when pressed against at least one string of a string instrument and return to its original shape when the pressure is released, thereby enhancing the interaction between said second portion and said at least one string to improve sound production.

19. The mechanism of claim 1, further comprising external shock absorbers configured to enhance the flexibility of said elastic circumferential layer.

20. The mechanism of claim 1, wherein said bow mechanism comprises two wheels and wherein said circumferential layer is wrapped around both wheels, such that the gap between the two wheels provides elasticity to said circumferential layer, allowing it to deform when pressed against at least one string and return to its original shape when the pressure is released.
